(19) United States
(12) Patent Application Publication
(10) Pub. No.: US 2007/0294310 A1
(43) Pub. Date: Dec. 20, 2007

(54) Method and apparatus for storing and recovering fixed content

(75) Inventor: Yuichi Yagawa, Yokohama (JP)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/448,415

(22) Filed: Jun. 6, 2006

(51) Int. Cl. G06F 17/30

(52) U.S. Cl. 707/200

(57) ABSTRACT

Fixed Content Aware Storage (FCAS) system includes a file system configured to store the Fixed Content data and a database system configured to manage the stored Fixed Content and its metadata along with other related information. Additionally, the FCAS includes data integrity resolving means. The data integrity resolving means executes a file system recovery procedure and a database recovery procedure. The two recovery procedures are executed separately, whereupon the data integrity resolving means compares the corresponding lists of entries in both the file system and the database from viewpoint of pointers. Subsequently, the data integrity resolving means selects and recovers only entries having the complete file and metadata pointers and extracts and stores all pointer-incomplete entries, files and metadata, in temporary memory area. The inventive FCAS also contains a recovery point extracting means, which, upon a request from the archive software, extracts and returns to the archiving software a recovery point as well as other recovery-related information.

### DESCRIPTION OF THE INVENTION

1. Field of the Invention

The present invention generally relates to storage systems and in particular to a method and apparatus for storing and recovering fixed content.

2. Description of the Related Art

Fixed Content information is usually defined as data that does not change once it is stored in a storage system. Sometimes, Fixed Content is also referred to as Reference Information. At the present time, many enterprises are interested in archiving data associated with various applications, such that the archived data is managed and preserved for extended periods of time, thus becoming Fixed Content. The archiving and preservation of data is necessary, for example, to achieve compliance with government regulations in the financial and medical areas, which require certain data to be preserved unchanged. Exemplary regulations include, without limitation, Securities and Exchange Commission (SEC) Rule 17a-4, HIPAA, and Sarbanes-Oxley Act (SOX).

The vast amount of fixed content data that needed to be preserved necessitated the development of Fixed Content Aware Storage (FCAS), which is a storage that is specially designed to store and manage Fixed Content data. In the computer industry, the FCAS is also referred to as CAS, which stands for Content Addressing Storage, Content Aware Storage or Content Archive Storage. Regarding CAS or FCAS in detail, please refer to the SNIA (Storage Networking Industry Association) tutorial material, which is submitted with this disclosure.

Exemplary FCAS products available on the market include, without limitation, EMC CENTERA, IBM DR550, HP RISS, STK INTELLISTORE AND ARCHIVAS ARC. NETAPP NEARSTORE along with its SNAPLOCK capability may be also categorized as FCAS. Sun Microsystems, Inc. has also announced their next generation FCAS called HONEYCOMB.

Generally, storage systems incorporate various mechanisms to protect data, which may include, without limitation, creating more than one copy of primary data, data recovery, as well as recreating a past operational state of data. Data recovery may involve recreation of a past operational state of an entire application or computing environment. Recovery may be required after an application or computing environment has crashed or otherwise rendered inoperable. It may include restoration of application data, if that application data had been destroyed or corrupted. The operational state needs to be guaranteed by the application that creates the data.

FCAS systems, in turn, must provide a mechanism to protect and recover the stored Fixed Content. Recovering FCAS means recreating a past operational state of the Fixed Content. The operational state of the Fixed Content is guaranteed by the application, which is usually an archiving system. This past operational state is also referred to as a recovery point. Generally speaking, finding an appropriate recovery point is a challenge.

One of the conventional technologies utilized for enabling the data protection mechanism in FCAS systems is an object based replication and restore. In accordance with this technique, a file embodying a fixed content, a metadata, describing the nature of the content, associated with it, and a retention and management policy are packed into an object. The aforesaid object may additionally contain any other related information. More than one copy of the object is created and stored separately from the original object, preferably on different storage nodes and/or sites. In case the original copy of the object gets compromised, it is replaced with one of the available copies.

As would be appreciate by those of skill in the art, in order to implement the FCAS with the data protection capabilities, the system must be provided with data replication and restore facilities. As would be also appreciated by artisans, implementing replication environment, especially for remote replication, requires substantial additional investment. On the other hand, many enterprises already have remote replication platform for business continuity or disaster recovery purpose. Those users may want to leverage their existing environment to achieve data protection in FCAS to eliminate costs associated with implementing new replication environment.

Moreover, the remote replication platforms that have been implemented at many enterprises are block based replication, which is different from object based management in terms of data granularity. Therefore, recovering FCAS requires resolving data integrity. Finally, in order to restart the archiving properly, the archiving system needs to be able to determine from which point the recovery operation should be started.

Therefore, what is needed is a technique that would enable replication and recovery in FCAS by leveraging the existing replication environment in order to eliminate additional development costs; that would provide means of resolving data integrity when recovering FCAS, leveraging block based replication, and/or that would allow the archiving software to determine a recovery point for initiating the archiving operation.

### SUMMARY OF THE INVENTION

The inventive methodology is directed to methods and systems that substantially obviate one or more of the above and other problems associated with conventional techniques for storing and recovering fixed content data.

According to one aspect of the inventive technique, there is provided a computerized system for storing and recovering fixed content data, the system comprising. The inventive system includes a storage system comprising at least one first storage unit and configured to receive and store the fixed content data and a metadata associated with the fixed content data, the fixed content data and the metadata being stored in the storage system under control of an archiving software. The inventive system further includes a gateway system operatively coupled to the storage system, the gateway system comprising a data integrity resolving module. The gateway system is operable, in response to a request from the archiving software, to furnish a recovered fixed content data and the metadata to the archiving software. The data integrity resolving module is operable to recover the stored fixed content data and the metadata and resolve data integrity issues between the recovered fixed content data and the metadata.

According to another aspect of the inventive technique, there is provided a computerized system for storing and recovering fixed content data. The inventive system includes a first host executing an application software; a second host operatively coupled to the first host via an interconnect, the second host executing an archiving software; a storage system operatively coupled with the first host and comprising at least one first storage unit and configured to receive and store the fixed content data and a metadata associated with the fixed content data, the fixed content data and the metadata being stored in the storage system under control of the archiving software; and a gateway system operatively coupled to the storage system and the second host, the gateway system comprising a data integrity resolving module. The storage system is further configured to store data associated with the application software. The gateway system is operable, in response to a request from the archiving software, to furnish a recovered fixed content data and the metadata to the archiving software. The data integrity resolving module is operable to recover the stored fixed content data and the metadata and resolve data integrity issues between the recovered fixed content data and the metadata.

According to yet another aspect of the inventive technique, there is provided a computer-implemented method for recovering a fixed content stored in at least one storage volume, which includes at least one file system. In accordance with the inventive method, the storage volume(s) are prepared for recovery operation, whereby the associated file system(s) are recovered produce a plurality of file entries corresponding to the stored fixed content. Next, database storing metadata associated with the fixed content is recovered to produce a plurality of metadata entries. Thereafter, pointer information associated with the file entries is compared with pointer information associated with the metadata entries to resolve data integrity issues between the fixed content data and the metadata. After that, only the file entries and the metadata entries which have complete pointer information are selected and recovered.

According to yet further aspect of the inventive technique, there is provided a computer-implemented method for obtaining a recovery point by an archiving software. According to the inventive method, a command including a request to a fixed content storage and recovery system for recovery point is being generated. The generated command is sent to the fixed content storage and recovery system, which stores a fixed content and a metadata associated with the fixed content. After the command is received at the fixed content storage and recovery system, it is being processed by that system to obtaining the recovery point. After the recovery point is obtained, it is returned to the archiving software. Upon the receipt of the recovery point, the archiving software re-starts the archiving process from the received recovery point.

According to yet further aspect of the inventive technique, there is provided a computer-implemented method for resolving data integrity between multiple files and multiple metadata records in a fixed content aware system. According to the inventive method, the completeness of data in each file and each metadata record is checked. Files and metadata records having incomplete data are eliminated. Further, pointer information associated with each file and each metadata record are compared and pointer incomplete metadata records are further eliminated.

According to yet further aspect of the inventive technique, there is provided a computerized system for storing and recovering fixed content data. The inventive system includes a first host executing an application software and a second host coupled to the first host via an interconnect. The second host executes an archiving software. The inventive system further includes a storage system coupled to the first host and configured to store application data associated with the application software, which may include fixed content data. The inventive system further include a fixed content aware system including at least one storage unit configured to receive and store the fixed content data and a metadata associated with the fixed content data. The fixed content data and the metadata are stored in the storage unit under control of the archiving software. The fixed content aware system further includes a replication module facilitating replication of the fixed content data from the storage system to the fixed content aware system; and a data integrity resolving module configured to recover the stored fixed content data and the metadata and resolve data integrity issues between the recovered fixed content data and the metadata.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an exemplary embodiment overall computer system architecture, which includes inventive FCAS system;

FIG. 2 shows an exemplary embodiment of system architecture.

FIG. 3 shows another exemplary embodiment of system architecture.

FIG. 4 shows an exemplary embodiment of system architecture of consolidated remote application.

FIG. 5 shows an exemplary embodiment of FCAS software architecture (related components only).

FIG. 6 shows an exemplary embodiment of metadata table.

FIG. 7 shows an exemplary embodiment of a process of resolving data integrity.

FIG. 8 shows an exemplary manner of resolving data integrity.

FIG. 9 shows an exemplary embodiment of a protocol of inquiring recovery point.

FIG. 10 shows examples of information that can be provided by FCAS in response to a request.

FIG. 11 shows an exemplary embodiment of system architecture of the second embodiment.

FIG. 12 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

According to an exemplary embodiment of the present invention, an inventive FCAS system includes a file system configured to store the Fixed Content data and a database system configured to manage the stored Fixed Content and its metadata along with other related information like retention and management policy. Additionally, the inventive FCAS includes data integrity resolving means. The data integrity resolving means executes a file system recovery procedure and a database recovery procedure. The aforesaid two recovery procedures are executed separately, whereupon the data integrity resolving means compares the corresponding lists of entries in both the file system and the database from viewpoint of pointers. Subsequently, the data integrity resolving means selects and recovers only entries having the complete file and metadata pointers and extracts and stores all pointer-incomplete entries, files and metadata, in temporary memory area. The inventive FCAS also contains a recovery point extracting means, which, upon a request from the archive software, extracts and returns to the archiving software a recovery point as well as other recovery-related information. Specifically, the aforesaid recovery point extracting means may furnish the content identifier (ID) and/or the timestamp of the recovery point. In an embodiment of the invention, the recovery point is the very last entry corresponding to pointer complete files and metadata. In addition to the recovery point, the recovery point extracting means may furnish to the arching software the file identifiers (ID) of pointer incomplete files, attributes of pointer incomplete metadata as well as the timestamps of files and metadata, which the archiving software may utilize to confirm that the utilized data is the most recent.

### 1. First Embodiment

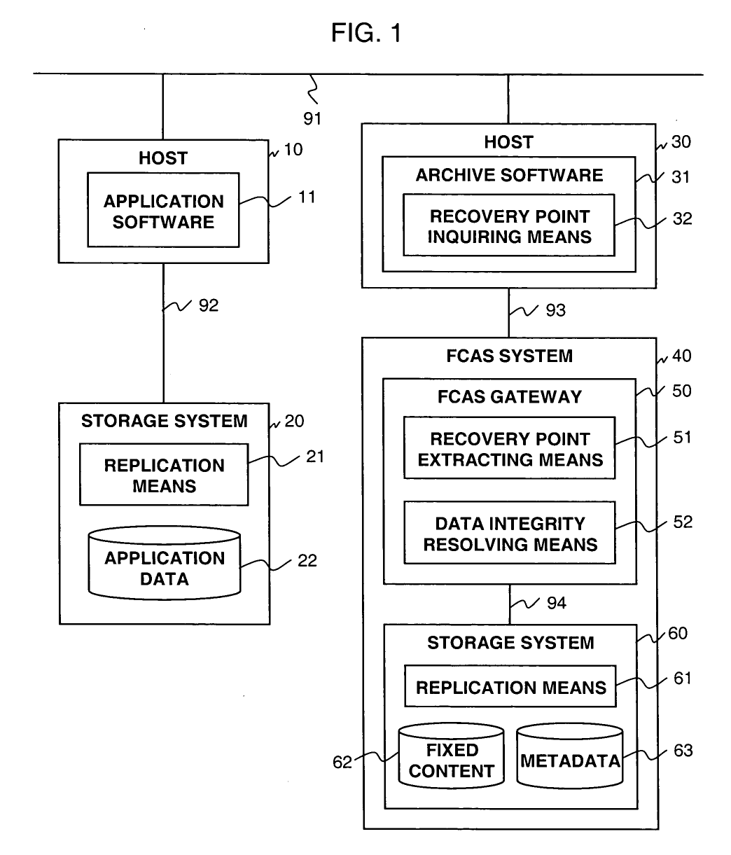

### 1.1 System Architecture (FIGS. 1, 2 and 3)

FIG. 1 shows overall computer system architecture, which includes inventive FCAS system 40. The system architecture shown in FIG. 1 includes a host 10, which executes application software 11. The system further includes storage system 20, which stores and manages the application data 22, host 30 executing archive software 31, as well as the FCAS system 40. The number of hosts 10 and 30, as well as storage system 20 and FCAS 40 is not limited to one. The host 10 and the host 30 communicate through LAN (Local Area Network) 91.

The host 10 and the storage 20 communicate through storage network 92, which may include one or more network switches. Exemplary embodiments of the storage network 92 include, without limitation, FibreChannel, ESCON, FICON, and IP networks, implementing the iSCSI, NFS, CIFS, HTTP, WebDAV, and/or any other IP-based storage access protocols.

The host 30 and the FCAS 40 also communicate through a storage network, which is designated in FIG. 1 by numeral 93, which may include one or more network switches. IP networks utilizing NFS, CIFS, HTTP, WebDAV and other well-known IP-based access protocols may be employed in implementing the network 93.

The host 10 can be implemented based on any suitable computer platform including, without limitation, mainframe, UNIX based or Windows based. Examples of the application software 11 include database, email, file server and other similar applications.

The storage system 20 can be implemented based on any known storage system architecture, including, without limitation, a block-based external storage system architecture, NAS (Network Attached Storage) architecture and the like. Examples of commercially-available implementations of the storage 20 include, without limitation, Hitachi TagmaStore USP, NSC, AMS and WMS. The implementation of the storage network 92 may vary depending on the details of the implementation of the storage system 20. Additionally, the storage system 20 may include replication means 21 configured to facilitate the replication of application data 22 stored in the storage system 20 to a remote storage system.

The host 30 may also be implemented based on a variety of existing computer platforms. The archiving software 31 executing on the host 30 communicates with the application software 11 executing on the host 10, facilitates the archiving of the application data 21 and stores archive data, consisting of fixed content 62, its metadata 63 and other related data, to the inventive FCAS 40. Examples of the archive software 31 include email archive software, database archive software, file archive software, and the like. The system architecture depicted in FIG. 1 is not limited to archiving software. Specifically, any software, including ECM (Enterprise Content Management) can be used in conjunction with the system configuration shown in FIG. 1.

In one embodiment of the invention, the archiving software 31 may include means 32 configured to issue a query to the FCAS system 40, requesting the FCAS system 40 to furnish the information on the recovery point to the archiving software 31.

An exemplary embodiment of the inventive FCAS system 40 shown in FIG. 1 includes FCAS gateway 50 and storage system 60. It should be noted that the FCAS system 40 may include more than one gateway 50 and/or more than one storage system 60.

The aforesaid gateway 50 and the storage 60 may communicate through storage network 94, which may be implemented using one or more network switches. The set of exemplary embodiments of the storage network 94 may be the same as the embodiment of the storage network 92. In one embodiment of the invention, FibreChannel and/or iSCSI networking interconnects are utilized for purposes of implementing the storage network 94. Additionally, in one system implementation, the storage network 94 is not accessible from the outside of the FCAS system 40.

The gateway 50 provides object-based interface and may be implemented using specialized software executing on one of the host computers of the system. The FCAS software may implement any required or desired FCAS functionalities including, without limitation, data retention management, WORM (Write Once Read Many), shredding, namespace management, auditing and the like.

The storage system 60 can be based on any existing storage system architecture, such as a block based external storage system, NAS (network Attached Storage) and the like. Commercially available products, which may be used in implementing the storage system 60 include, without limitation, Hitachi TagmaStore USP, NSC, AMS and WMS. The storage system 60 stores and manages the fixed content 62, its metadata 63 and any other related data (not shown).

The storage system 60 includes replication means 61, which is leveraged to protect the fixed content 62, its metadata 63 and other related data by replicating the respective information.

The embodiment of the FCAS Gateway 50 shown in FIG. 1 includes Data Integrity Resolving Means 52 and Recovery Point Extracting Means 51. In an embodiment of the inventive system, the replication means 61 enables block based data replication operations, and does not support objects. To enable the inventive FCAS system to manipulate objects as opposed to blocks, the Data Integrity Resolving Means 52 it provided to resolve data integrity issues associated with the objects under block based replication. Additional details on the operation of the Data Integrity Resolving Means 52 will be provided below.

The FCAS gateway 50 additionally includes Recovery Point Extracting Means 51. In one embodiment of the invention, the archive data is protected by way of replication, wherein the archive data 22 is copied and stored in any storage means. Therefore, the archive data can be re-generated by the archive software 31 as long as the archive software is aware of the corresponding recovery point. The Recovery Point Extracting Means 51 determines the recovery point and returns it to the archive software 31 upon a request from the recovery point inquiring means 32.

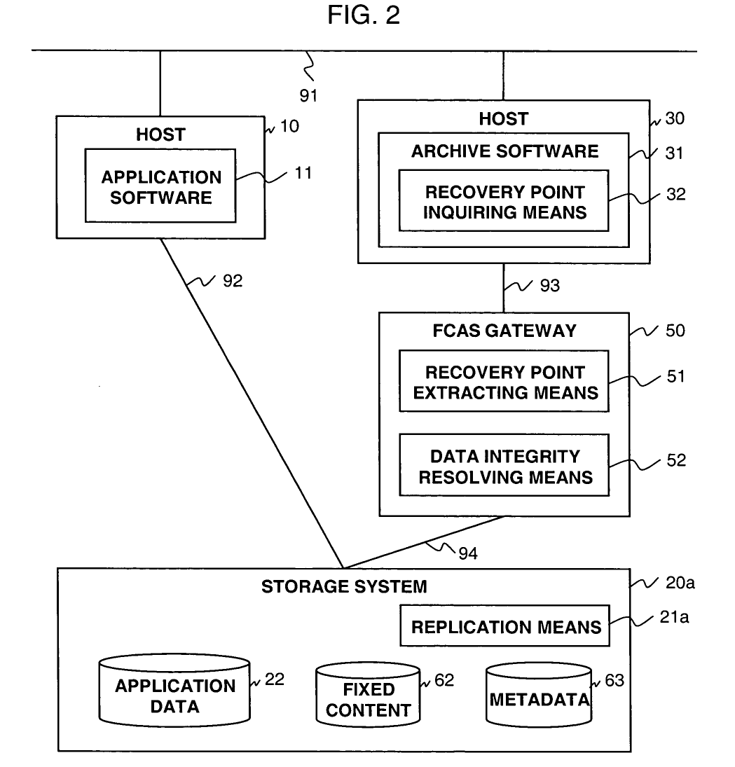

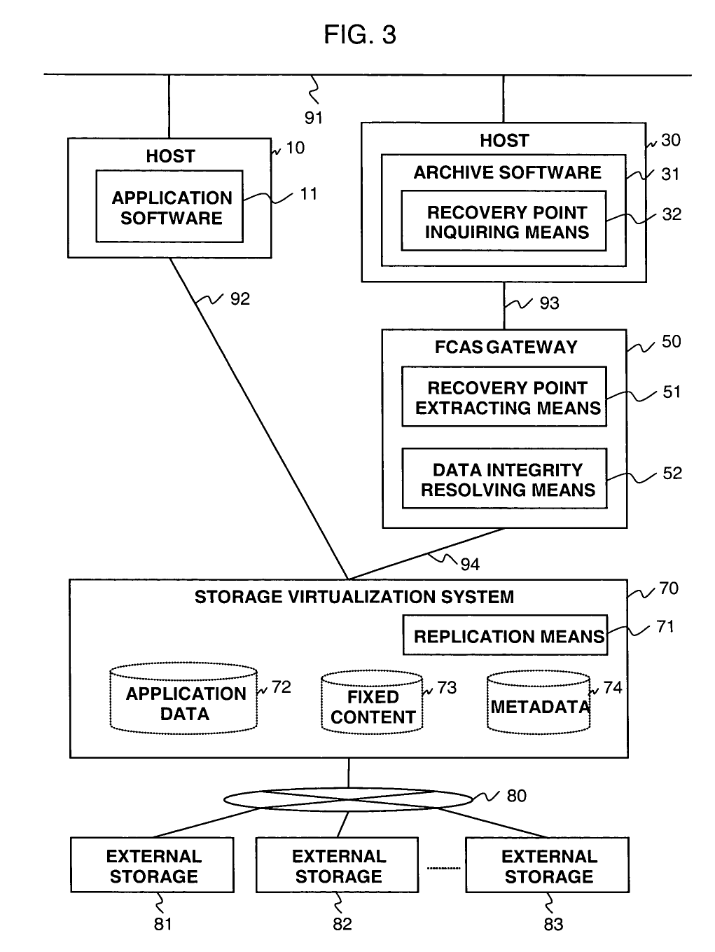

### 1.2. Other System Architectures (FIGS. 2 and 3)

FIGS. 2 and 3 show other possible system architecture configurations of the first embodiment of the inventive system. In the configuration shown in FIG. 2, the FCAS gateway 50 shares the storage system 20a with other elements of the system, including, for example, the host 10. The archive software 31 generates the archive data, which includes the fixed content 62 and metadata 63 while the FCAS gateway 50 stores and manages these data in the storage 20a. In addition to the fixed content 62 and metadata 63, the storage system 20a stores application data 22, which is generated by application software 11 executing on the host 10.

The storage system 20a may additionally incorporate data and metadata replication means 21a, as well as other functions and platforms, including, without limitation, replication management software, administrator's management process and skills, and network infrastructures for remote replication.

In this system configuration, the application software 11 and the archive software 31, together with the FCAS gateway 50 share the same storage system 20a, thereby achieving the consolidation of the utilized storage devices. Because no additional separate storage system is required, the initial costs of setting up the system depicted in FIG. 2 and the associated operating costs are minimized.

The system configuration shown in FIG. 3 is characterized by the storage virtualization system 70. The FCAS gateway 50 shares the storage virtualization system 70 with other system components. The primary distinguishing features of this configuration compared with the configuration shown in FIG. 2 are as follows. First, in the configuration of FIG. 3, the storage virtualization system 70 manages virtual volumes 72, 73 and 74, while the actual data corresponding to these volumes are stored and managed in external storages 81, 82 and 83. Second, because the virtual volumes 72, 73 and 74 appear identical to the hosts and to any other functional components of the system, including the replication means 71, this system architecture also consolidates the replication platform among FCAS and other subsystems. Finally, by leveraging the existing external storages, the system architecture of FIG. 3 can also reduce initial system deployment costs.

It should be noted that not all the data needs to be stored at the external storage units 81, 82 and 83, but some of the data may be stored in a storage area in the storage virtualization system 70. For example, the application data 72 may require a high storage system performance and, therefore, this data should be stored in the storage virtualization system 70. The metadata 73 may impose the same performance requirements as the application data 72, because various search functions use these metadata. Therefore, the metadata may also need to be stored in a high performance storage virtualization system 70. However, the fixed content 73, itself may not require advanced storage performance characteristics, but require low a TCO (total cost of ownership). Therefore, such fixed content may be stored in cheap external storage units. The aforesaid concept is usually called as HSM (Hierarchical Storage Management) or even ILM/DLM (Information/Data Lifecycle Management).

The storage virtualization system 70 will now be described. Recently, the virtualization has become one of popular technologies in the storage industry. The term virtualization is utilized to characterize an act of integrating one or more (back end) services or functions with additional (front end) functionality for the purpose of providing useful abstractions. Typically, virtualization hides some of the back end complexity, or adds or integrates new functionality with existing back end services. Examples of virtualization are the aggregation of multiple instances of a service into one virtualized service, or adding security to an otherwise insecure service. Virtualization can be nested or applied to multiple layers of a system.

Virtualization system is a system that incorporates the facilities for providing the virtualization functionality. Exemplary embodiments of commercially available virtualization systems, include, without limitation, Hitachi USP (Universal Storage Platform) having a virtualization engine called Universal Volume Manager, IBM SVC (SAN Volume Controller), EMC Invista, CISCO MDS, and the lime. It should be noted that some available virtualization systems, such as Hitachi USP, themselves incorporate an integral storage system.

Other suitable exemplary virtualization systems are described in Japanese patents No. 10-283272 and 2004-5370, which are incorporated herein by reference in their entirety.

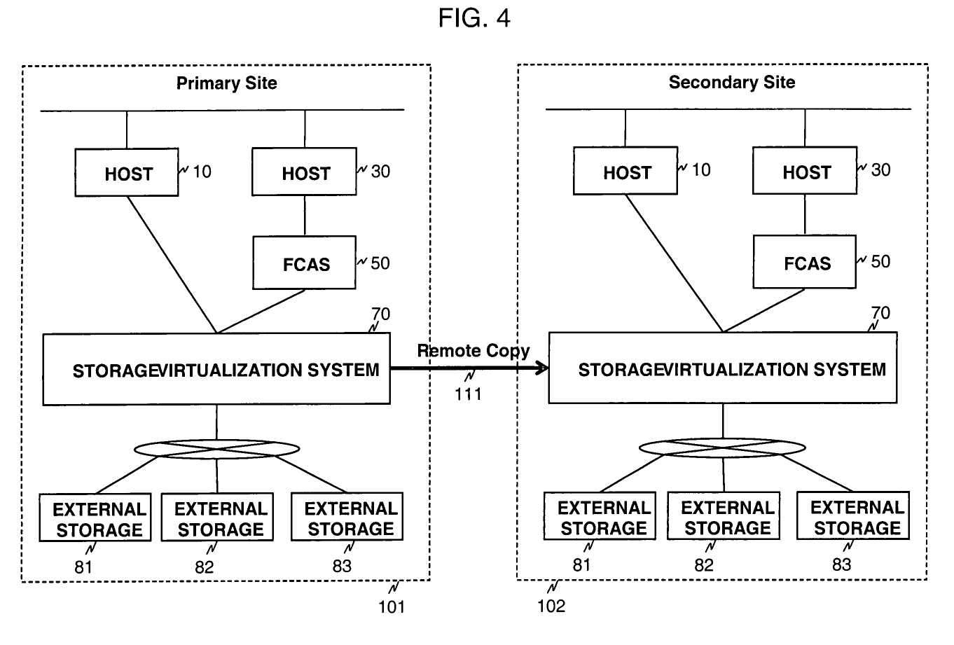

### 1.3. Consolidated Remote Replication (FIG. 4)

FIG. 4 shows exemplary system architecture providing consolidated remote replication. In the depicted system, not only the application data but also the archive data are copied from the production site 101 to secondary site 102, via remote copy link 111, and, thus, all the data are protected. Because the replication platform is shared among the production system (application) and the archive system, users can effectively eliminate operating costs as well as initial deployment costs. The system shown in FIG. 4 is based on the system of FIG. 3, but it can also be based on other suitable architectures, for example the architectures shown in FIGS. 1 and 2.

In-system replication also can be consolidated (not shown in the figures). Not only the application data but also the archive data are copied from the primary volumes to secondary volumes, by using in-system replication means, the replicated data may be also copied to outside storage media like tapes and, thus, all the data are protected. Because the replication platform is shared among the production system (application) and the archive system, users can effectively eliminate operating costs as well as initial deployment costs.

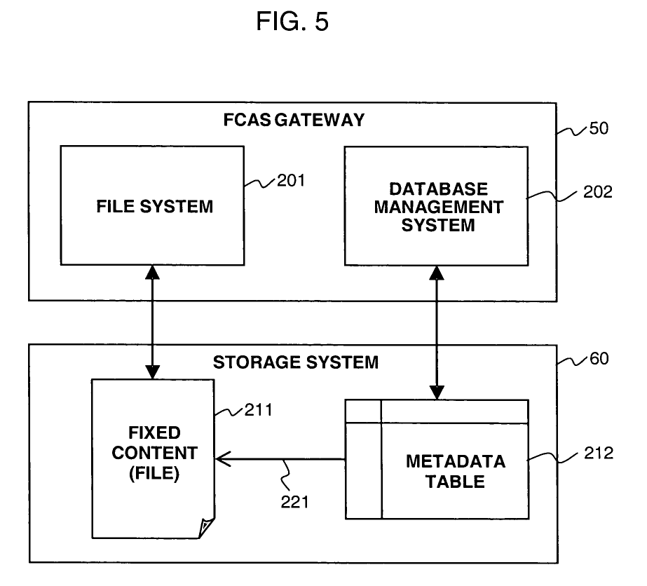

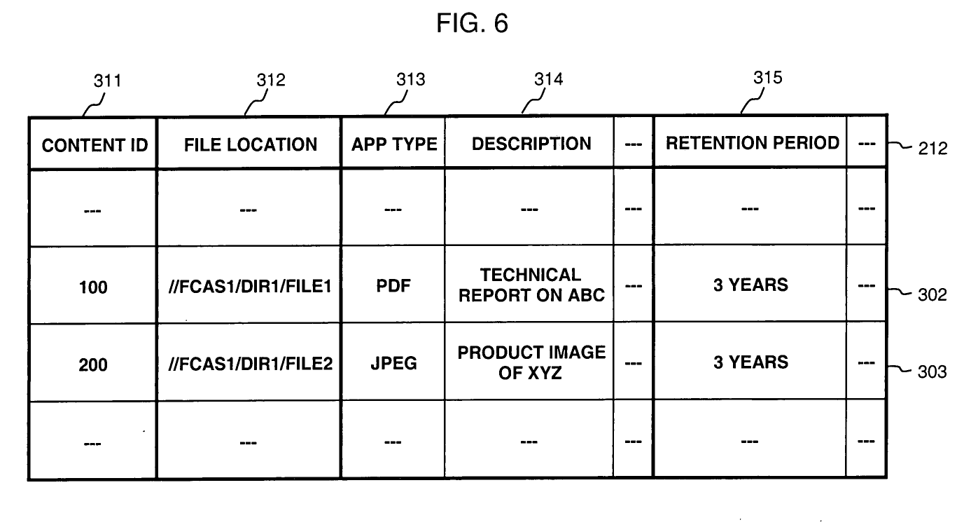

### 1.4. FCAS Software Architecture and Data Structure (FIGS. 5 and 6)

FIG. 5 shows a portion of the software architecture of the inventive FCAS system and illustrates the interrelationships between various software components thereof. The managed fixed content is represented in the inventive FCAS system in form of files 211. To this end, the inventive FCAS incorporates file system 201, which facilitates the management of the fixed content. Also, the metadata as well as other data related to the fixed contents are managed as metadata table 212 stored in in database. To facilitate the management of the table 212, the inventive FCAS includes DataBase Management System 202. It should be noted that the metadata table 212 stored in the database incorporates pointers or references 221 pointing to appropriate fixed content instances 211. In other words, the pointers or references 221 contained in the metadata table 212 describe the location of the files 211, which represent the instances of the fixed content stored in the system. Examples of the fixed content instances are emails, financials as well as medical image data.

FIG. 6 illustrates an exemplary embodiment of the metadata table 212. Generally, the metadata table 212 stores information describing the fixed content. More specifically, columns 311 through 315 of the table 212 represent exemplary metadata attributes. In particular, content ID column 311 stores an unique identifier assigned to each fixed content instance. The content ID may be assigned to a specific fixed content instance by the archive software or by the inventive FCAS.

File location column 312 identifies the storage location where the file corresponding to a specific fixed content instance is stored. In the example shown in FIG. 6, the file location 312 is expressed as a file system file access path, but the exact format of the file location record 312 may depend on the implementation details of the specific file system used, which may include, without limitation, NFS, CIFS, HTTP, WedD and the like. More importantly, the file location attribute points to the stored fixed content instance 211. In another embodiment, one fixed content instance consists of several separate portions, which are stored in the FCAS. In such a case, the file location attribute 312 contains several file location records.

The value in the application type column 313 indicates the type of the application that generated the original fixed content data. This attribute is used, for example, when the fixed content is reused in the future.

The description column 314 briefly describes the information contained in the fixed content. This attribute is useful, for example, in searching for appropriate fixed content instance. The application type attribute 313 and the description attribute 314 are examples of fixed content metadata.

Retention period attribute 315 specifies how long the fixed content will be preserved. The metadata table may further specify a process, which is utilized for, example, to dispose of the fixed content, when the fixed content retention period expires. For example, after the prescribed retention period expires, the fixed content may be subject to deletion and/or shredding. The retention period attribute 315 is an example of fixed content management policies.

As the other attributes, each metadata instance may have an associated timestamp indicating when the metadata was last updated. This timestamp may be accessible by the archive software as will be described in detail below. The rows 302 and 303 of table 212 shown in FIG. 6 illustrate two exemplary metadata records.

The inventive process for resolving data integrity issues may be initiated by an administrator, archiving software, the FCAS system itself as well as other system components. Furthermore, the inventive process may be initiated from any location, where the replicated data is stored, including for example, a secondary data storage site.

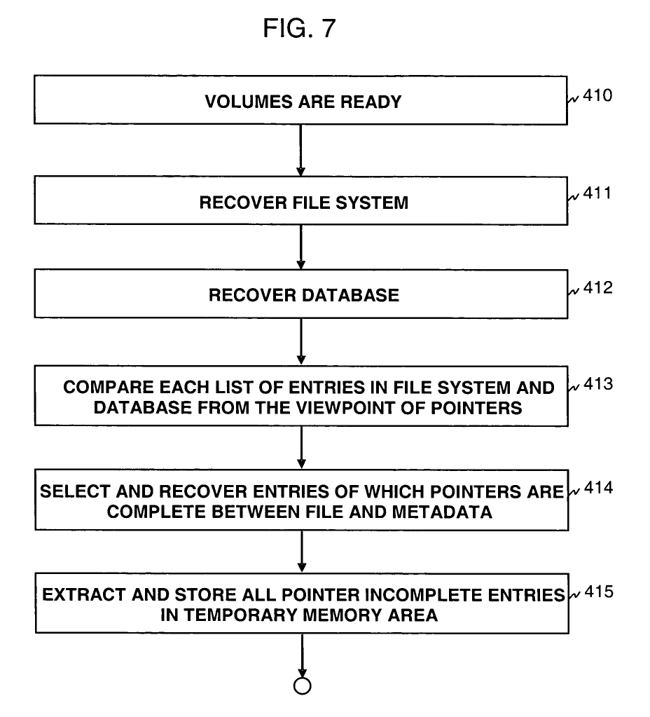

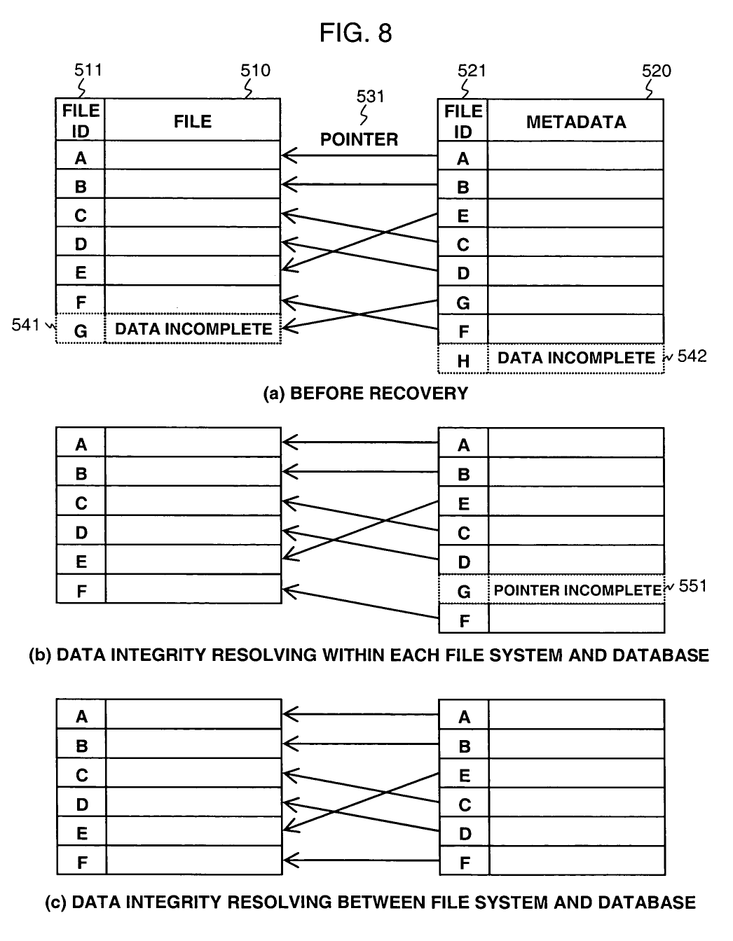

### 1.5. Process for Resolving Data Integrity (FIGS. 7 and 8)

FIG. 7 illustrates a process of resolving data integrity issues. The data integrity resolving means 52, which performs the aforesaid process, may be implemented as software program based, for example, on the algorithm illustrated in FIG. 7. FIG. 8 provides another illustration of the operation of the exemplary embodiment of the inventive data integrity resolving algorithm. Specifically, FIG. 8 illustrates interlinking of two types of data: fixed content data (in the file form) 510 and the associated metadata 520 before and after recovery and data integrity resolving. With reference to FIG. 8, each file 510 containing fixed content data has its own associated file ID 511. Each metadata record 520, corresponding to the file 510, also contains file ID 521, in order to enable the metadata record to point or refer to an appropriate file 510. This achieves a pointer 531. Records in FIG. 8 are written sequentially, in accordance with the sequential order of their file ID identifiers. Thus, for example, record with the file ID “D” is written after the record with file ID “B”.

Now, the process illustrated in FIG. 7 will be described in detail. The execution of the process begins at step 410. At this step, all the storage volumes located on a storage system (for example storage system 60) associated with the FCAS, are prepared for an access operation. The prepared storage volumes contain past operational state of data. For example, during this step, a data path linking the FCAS system to the respective volumes is configured, and the FCAS system mounts the required volumes.

As shown in FIG. 8(a), at the time of completion of the aforesaid step 410, the file 510 and metadata 520 may contain some incomplete data because, for example, of unplanned outages or errors, which may have prevented the proper completion of one or more WRITE operations.

At step 411, the inventive FCAS recovers its file system. Recovering the file system is a well known technology to persons of skill in the art. The exact manner of the recovery procedure depends on the implementation of the storage system(s) involved. Therefore, the details of the implementation of the file system recovery are not essential to the concept of the present invention. For example, during the aforesaid file system recovery step 411, the file 541 that has been written last is checked for completeness. More specifically, the contents of the file 541 may be checked for data integrity. If data integrity problems are encountered, the file 541 is withdrawn. The described file system recovery step is sometimes referred to as File System Crash Recovery or fsck (file system check)

At step 412, the FCAS recovers its database. Recovering the database is also a well known technology. The exact manner of the database recovery procedure depends on the implementation of the data system(s) involved. Therefore, the details of the implementation of the database system recovery are not essential to the concept of the present invention. For example, during the database recovery step 412, the metadata entry 542, which appears in the database log subsequently to a checkpoint (not shown), is checked for completeness and/or the integrity of the data that it contains. If any data completeness and/or integrity problems are discovered, the entry 542 is withdrawn. The described database recovery step is sometimes referred to as Database Crash Recovery.

FIG. 8 (b) illustrates the status of files and metadata records in the storage and database systems, respectively, after the data integrity is resolved within each file system and database during the aforesaid steps 411 and 412.

At step 413, the inventive FCAS system compares pointer information associated with each of the entries in the list of files stored by the file system and the list of metadata records stored in the database. During this step, the system checks for existence of any files that are not pointed to by at least one metadata record. In addition, the system checks for any metadata records that do not point to at least one file and/or for any metadata records, which point to files that do not exist. The files and metadata identified at step 413 are referred to as pointer incomplete and designated in FIG. 8 by numeral 551. To facilitate the identification of the pointer incomplete entries in the aforesaid lists, the system may be provided with a search capacity to locate the file identifier (file ID) of the appropriate list entries.

At step 414, the inventive FCAS system selects and recovers only the file and metadata entries having complete pointer information. In other words, any pointer incomplete entries are deleted or moved to a temporary memory space. The removed entries are logically incomplete and need to be archived again. FIG. 8 (c) shows the status of the Fixed Content (file) and the associated metadata entries after the data integrity has been resolved between file system and database in accordance with the aforesaid step 413 and 414.

At step 415, the inventive FCAS extracts and stores all pointer incomplete entries, including files and metadata, in the temporary memory area. Those data may be accessed and re-used by recovery point extracting means 51 as well as other system components.

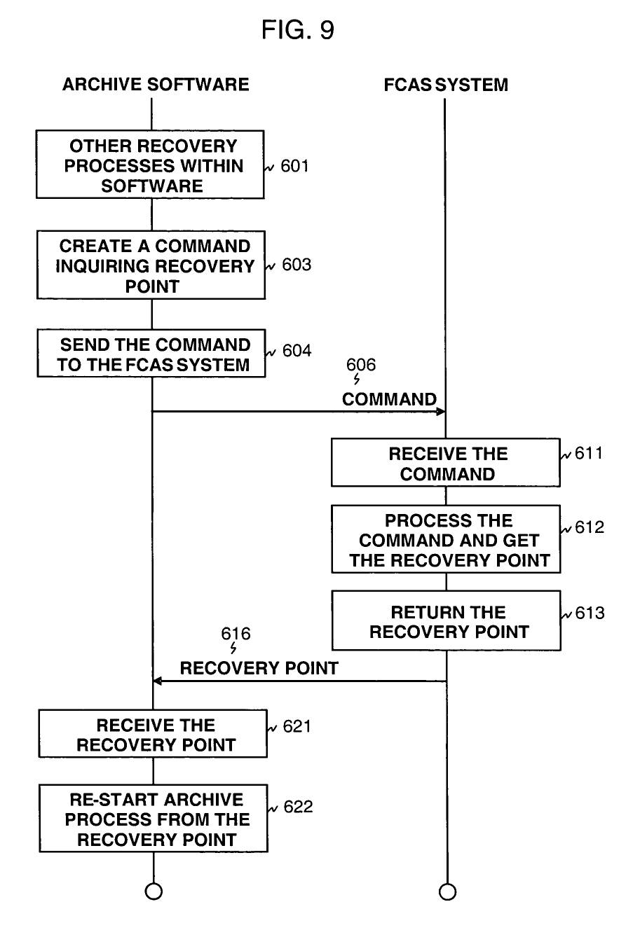

The inventive procedure for obtaining a recovery point is described with reference to FIGS. 9, 10 and 11. FIG. 9 shows a protocol for obtaining a recovery point from the inventive FCAS system. Specifically, at step 601, the archiving software performs other operations, which are executed prior to issuing the recovery point query. At step 603, the archiving software generates a command 606, which includes a recovery point query to the FCAS system. The generated command 606 is sent to the FCAS at step 604. The FCAS receives the command 606 at step 611. At step 612, the FCAS processes the received command and obtains the recovery point in accordance with the described algorithm. At step 612, the FCAS returns the recovery point information to the requesting archiving software, which receives the recovery point at step 621. Subsequently, the archiving software restarts the archive process from the recovery point (step 622).

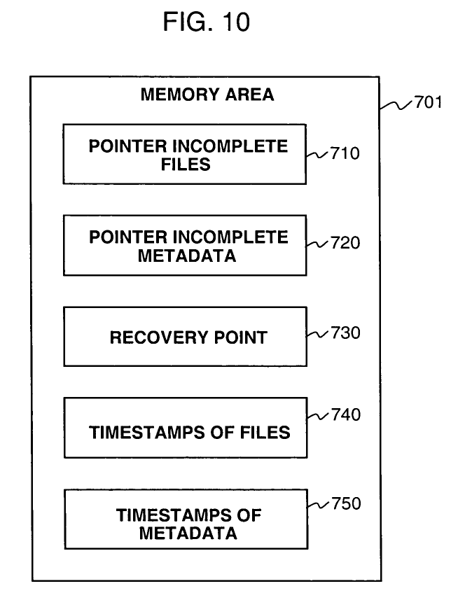

FIG. 10 provides examples of various types of information that can be requested by the archive software from the inventive FCAS system. The operating sequence shown in FIG. 9 illustrates only the situation wherein the recovery point is requested. However the same protocol can be applied to requests for any other information presented in FIG. 10. The aforesaid protocol may be implemented using API (Application Program Interface), CLI (Command Line Interface) and/or any other suitable method known in the art.

In another example, not illustrated in the figures, the archiving software may query the inventive FCAS system for the information on the pointer incomplete files and/pr pointer incomplete metadata shown in FIG. 10. This information may be used by the administrator to determine the reason for the incomplete information and to attempt resolution of the data completeness issues. In another example, the archiving software may use the file and metadata timestamps shown in FIG. 10 to search for appropriate fixed content to be recovered.

With reference to FIG. 10, the FCAS memory area 701 (not shown in FIG. 1) may contain the following stored data, which may be requested from the FCAS by the archive software. First, the memory area 701 may include pointer incomplete files 710. This information is extracted and stored in the memory area 701 during the execution of the step 415 shown in FIG. 7 and described in detail with reference to that figure. Upon a properly issued request, a list of file names or IDs of the pointer incomplete files may be returned to the archive software by the inventive FCAS system. Second, the memory area 701 may additionally store pointer incomplete metadata 720. This information is also extracted at the aforesaid step 415. Again upon a request from the archiving software 31, a list of various attributes of the pointer incomplete metadata may be returned to the archive software. Various examples of relevant attributes are presented in the table of FIG. 6. The command requesting the attribute information may specify the set of attributes to be returned. The memory area 701 may further store recovery point 730. The recovery point is described as the very latest entry corresponding to pointer complete files and metadata. The content identifier (ID) and/or the timestamp of the recovery point may be returned to the archive software upon request. In the example shown in FIG. 8, the file with the file ID “F” becomes the recovery point and would be returned to the archive software. Finally, the memory area 701 may store timestamps of files 740 and timestamps of metadata 750. The respective timestamps carry information on the date and time of creation or last modification of the files 510 and the associated metadata 520. To ensure that the data that is being recovered is the most recent, the archiving software 31 may search for the appropriate fixed content to be recovered by using the aforesaid stored timestamps along with other relevant information, which may include, without limitation, the content identifier (ID) information. As would be appreciated by those of skill in the art, other relevant information may be stored in the memory area 701.

For example, if the discrepancy between the timestamp of a fixed content file and the timestamp of the associated metadata's is greater than a predetermined threshold value, the archiving software may determine that the last update of either the file or the metadata has failed and that the currently available data is outdated and needs to be updated again.

### 2. Second Embodiment

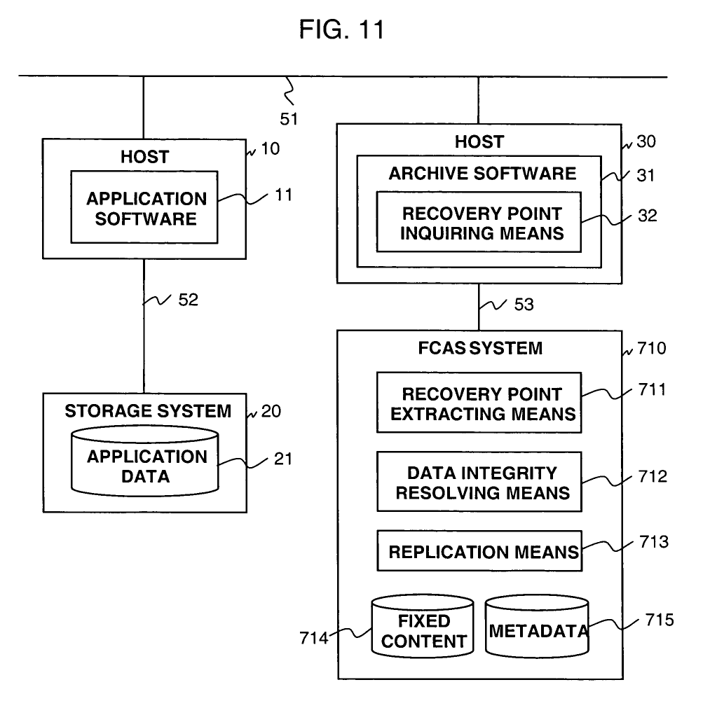

An exemplary system architecture of the second embodiment of the invention is shown in FIG. 11. The second embodiment is characterized in that the FCAS system 710 contains its own integrated storage means storing fixed content 714 and metadata 715 and replication means 713. Like in the first embodiment shown in FIG. 1 and described in detail hereinbefore, the archive software 31 contains the recovery point inquiring means 32. In addition, the FCAS of the second embodiment contains the recovery point extracting means 711. As a result, the archive software 31 can re-start the archiving process from the appropriate recovery point, which is obtained by appropriately querying the means 711. Finally, the FCAS system 710 incorporates the data integrity resolving means 712, which is generally equivalent to the corresponding element labeled with numeral 52 in FIG. 1.

### 3. Description of Computer Platform

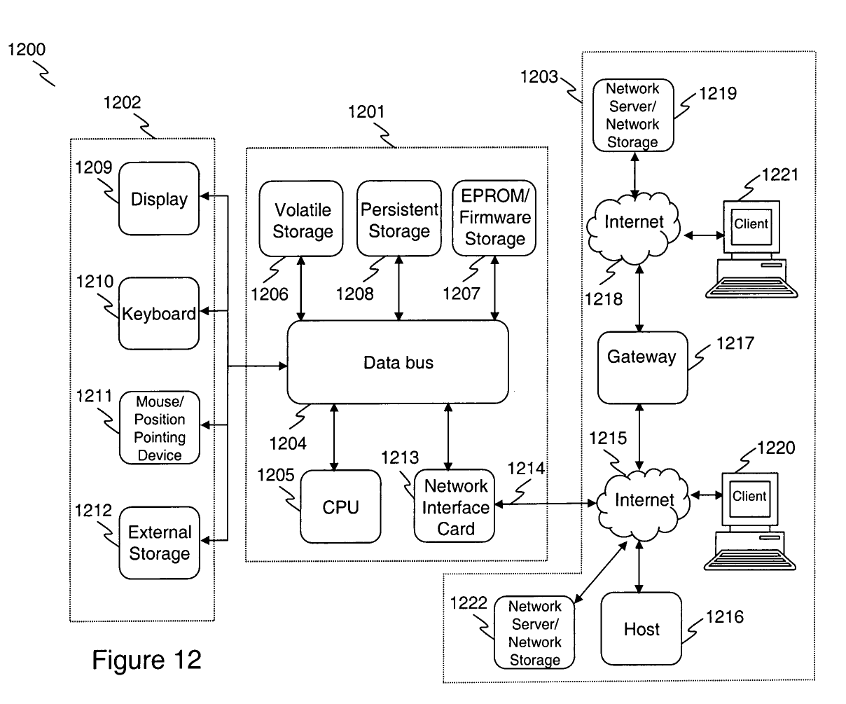

FIG. 12 is a block diagram that illustrates an embodiment of a general or special purpose computer system and network architecture 1200 upon which embodiments of various components of the inventive computerized system may be based. The system architecture 1200 may include a general purpose or special purpose computer platform 1201, peripheral devices 1202 and various network resources 1203. Various elements of the described computer platform 1201 may be used singly or in any suitable combination in implementing the aforementioned host 10, host 30, FCAS systems 40/50, storage system 20 and/or storage virtualization system 70, which have been described hereinabove.

The computer platform 1201 may generally include a processor 1205 for handling various information and performing other computational and control tasks. The computer platform 1201 may also include a volatile storage 1206, such as a random access memory (RAM) or other similar dynamic storage device for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device for storing static information and instructions for processor 1205, such as basic input-output system (BIOS), as well as various system configuration parameters. A persistent storage device 1208, such as a magnetic disk, optical disk, or solid-state flash memory device may be provided for storing information and instructions. Upon start of the computer platform 1201, it may be configured to automatically load and execute the instructions stored in the storage devices 1207 and/or 1208.

The aforementioned processor 1205, as well as storage devices 1206, 1207 and 1208 may be interconnected using a data bus 1204 facilitating exchange of data among various elements of the computer system 1201. The data bus 1204 may be implemented using any known computer interconnect mechanism, including, without limitation, PCI, SCSI, Infiniband, etc.

When the computer platform 1201 is utilized to implement the host 10 and host 30, it may be coupled via bus 1204 to a display 1209, such as a cathode ray tube (CRT), plasma display, or a liquid crystal display (LCD), for displaying information to a system administrator or user of the computer platform 1201. An input device 1210, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209. This input device typically has two degrees of freedom in two axes, a first axis (e.g., x) and a second axis (e.g., y), that allows the device to specify positions in a plane.

When the computer platform 1201 is used to implement the storage systems 20 and/or 60, as well as the storage virtualization system 70, one or more external storage units 1212 may be connected to the computer platform 1201 via bus 1204 to implement storage units 22, 62, 63 and 81-83 for storing various data and metadata. Additionally or alternatively, the aforesaid storage units may be implemented using persistent storage 1208 or network storage 1219 or 1222. In an embodiment of the computer system 1200, the external removable storage device 1212 may be used to facilitate exchange of data with other computer systems.

According to one embodiment of the invention, the functions of the host 10, host 30, FCAS systems 40/50, storage system 20 and/or storage virtualization system 70 are performed by an implementation of the computer platform 1201 in response to the processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that is capable of providing, directly or indirectly, instructions to processor 1205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1208. Volatile media includes dynamic memory, such as volatile storage 1206. Transmission media includes coaxial cables, copper wire and fiber optics, including the wires that comprise data bus 1204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1205 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The aforesaid host 10 and host 30 are designed to operate on a computer network 91. To this end, the computer platform 1201 also includes a communication interface, such as network interface card 1213 coupled to the data bus 1204. Communication interface 1213 provides a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11a, 802.11b, 802.11 g and Bluetooth may also used for network implementation. In any such implementation, communication interface 1213 sends and receives electrical, electromagnetic or optical signals that carry digital data streams representing various types of information.

Network link 1213 typically provides data communication through one or more networks to other network resources. For example, network link 1214 may provide a connection through local network 1215 to a host computer 1216, or an additional network storage/server 1222. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1215 and/or the Internet 1218. The network clients 1220 and 1221 may themselves be implemented based on the computer platform similar to the platform 1201.

Local network 1215 and the Internet 1218 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the data search and retrieval system. It is intended that the specification and examples be considered as exemplary only, with a true scope and spirit of the invention being indicated by the following claims.

1. A computerized system for storing and recovering fixed content data, the system comprising:
a. a storage system comprising at least one first storage unit and configured to receive and store the fixed content data and a metadata associated with the fixed content data, the fixed content data and the metadata being stored in the storage system under control of an archiving software; and
b. a gateway system operatively coupled to the storage system, the gateway system comprising a data integrity resolving module, wherein the gateway system is operable, in response to a request from the archiving software, to furnish a recovered fixed content data and the metadata to the archiving software and wherein the data integrity resolving module is operable to recover the stored fixed content data and the metadata and resolve data integrity issues between the recovered fixed content data and the metadata.

2. The computerized system of claim 1, further comprising a database configured to store the metadata as a plurality metadata entries.

3. The computerized system of claim 2, wherein the first storage unit comprises a file system configured to store the fixed content as file entries and wherein the data integrity resolving module is operable to separately recover the database and the file system.

4. The computerized system of claim 3, wherein each of the file entries and each of the metadata entries is associated with at least one pointer and wherein the data integrity resolving module is further operable to compare pointer information associated with each of the file entries stored in the file system and each of the metadata entries stored in the database to resolve data integrity issues between the fixed content data and the metadata.

5. The computerized system of claim 4, wherein the data integrity resolving module is further operable to select and recover only the file entries and the metadata entries which have complete pointer information.

6. The computerized system of claim 4, wherein the data integrity resolving module is further operable to extract and store all pointer incomplete file entries and all pointer incomplete metadata entries.

7. The computerized system of claim 6, further comprising a temporary memory area configured to store the pointer incomplete file entries and the pointer incomplete metadata entries.

8. The computerized system of claim 7, wherein the temporary memory area is further configured to store timestamps of the file entries and metadata entries.

9. The computerized system of claim 7, wherein the temporary memory area is further configured to store recovery point information, the recovery point being identified by a most recent pointer-complete file entry and a corresponding a most recent pointer-complete metadata entry.

10. The computerized system of claim 7, therein the gateway system is further operable, in response to a second request from the archiving software, to return to the archiving software at least portion of information stored in the temporary memory area.

11. The computerized system of claim 7, wherein the second request comprises data specifying the information to be returned.

12. The computerized system of claim 7, wherein the data integrity resolving module is further operable to extract and store all pointer incomplete file entries and all pointer incomplete metadata entries and to store the extracted entries in the temporary memory area.

13. The computerized system of claim 1, wherein the gateway system further comprises a recovery point extracting module operable, in response to a request from the archiving software, to determine a recovery point for the fixed content and the metadata and to return information on the recovery point to the archiving software.

14. The computerized system of claim 13, wherein the archiving software comprises recovery point inquiring module operable to issue the request to the recovery point extracting module of the gateway system.

15. The computerized system of claim 13, wherein the information on the recovery point comprises recovery point timestamp.

16. The computerized system of claim 13, wherein the information on the recovery point comprises recovery point timestamp.

17. The computerized system of claim 1, wherein the archiving software executes on a host coupled with the computerized system via an interconnect.

18. The computerized system of claim 1, further comprising:
a. A second host executing an application software, the second host being operatively coupled with the first host via a second interconnect; and
b. A second storage system comprising at least one second storage unit, the second storage system being operatively coupled with the second host via a third interconnect, the second storage system operable to receive application data from the application software and store the application data in the at least one second storage unit.

19. The computerized system of claim 18, wherein the second storage system further comprises application data replicating module operable to cause the application data stored in the at least one second storage unit of the second storage system to be replicated to the first storage system.

20. The computerized system of claim 19, wherein the first storage system further comprises second data replication module operable to facilitate the replication of the application data.

21. The computerized system of claim 1, further comprising a database storing the metadata associated with the stored fixed content, wherein the gateway system is operable to:
a. Prepare at least one storage volume stored in the storage system for a recovery operation;
b. Recover the at least one file system to produce a plurality of file entries corresponding to the stored fixed content;
c. Recover the database to produce a plurality of metadata entries;
d. Compare pointer information associated with each of the file entries and each of the metadata entries to resolve data integrity issues between the fixed content data and the metadata; and
e. Select and recovering only the file entries and the metadata entries, which have complete pointer information.

22. A computerized system for storing and recovering fixed content data, the system comprising:
a. A first host executing an application software;
b. A second host operatively coupled to the first host via an interconnect, the second host executing an archiving software;
c. A storage system operatively coupled with the first host and comprising at least one first storage unit and configured to receive and store the fixed content data and a metadata associated with the fixed content data, the fixed content data and the metadata being stored in the storage system under control of the archiving software; and
d. A gateway system operatively coupled to the storage system and the second host, the gateway system comprising a data integrity resolving module, wherein:
i. the storage system is further configured to store data associated with the application software.
ii. the gateway system is operable, in response to a request from the archiving software, to furnish a recovered fixed content data and the metadata to the archiving software; and
iii. the data integrity resolving module is operable to recover the stored fixed content data and the metadata and resolve data integrity issues between the recovered fixed content data and the metadata.

23. The computerized system of claim 22, wherein the storage system comprises a storage virtualization system operatively coupled to a plurality of external storage units via a storage interconnect, wherein:
1. The data associated with the application software is stored in a first virtual volume;
2. The fixed content data is stored in a second virtual volume;
3. The metadata is store in a third virtual volume; and
4. The first, second and third virtual volumes are allocated from the plurality of the external storage units.

24. The computerized system of claim 22, further comprising a database storing the metadata associated with the stored fixed content, wherein the gateway system is operable to:
a. Prepare at least one storage volume stored in the storage system for a recovery operation;
b. Recover the at least one file system to produce a plurality of file entries corresponding to the stored fixed content;
c. Recover the database to produce a plurality of metadata entries;
d. Compare pointer information associated with each of the file entries and each of the metadata entries to resolve data integrity issues between the fixed content data and the metadata; and
e. Select and recovering only the file entries and the metadata entries, which have complete pointer information.

25. The computerized system of claim 24, wherein the data integrity resolving module is further operable to determine a recovery point by identifying a most recent pointer-complete file entry of the plurality of file entries and a corresponding a most recent pointer-complete metadata entry of the plurality of metadata entries.

26-42. (canceled)
